(19) United States
(12) Patent Application Publication
(10) Pub. No.: US 2012/0144830 A1
(43) Pub. Date: Jun. 14, 2012

(54) FEED WATER DEGASIFIER FOR A SOLAR THERMAL POWER STATION

(75) Inventor: Ronald Ellert, Leimen (DE)

(73) Assignee: FLAGSOL GMBH, Köln (DE)

(21) Appl. No.: 13/202,568

(22) PCT Filed: Feb. 19, 2010
(86) PCT No.: PCT/EP2010/052163

§ 371 Date: Feb. 28, 2012

(30) Foreign Application Priority Data
Feb. 21, 2009 (DE) 10 2009 010 020.2

(51) Int. Cl. F03G 6/00; C02F 1/20; C02F 1/02; B01D 19/00

(52) U.S. Cl. 60/641.8; 96/218; 95/241

(57) ABSTRACT

The invention relates to a feed water degasifier comprising a degasifier (8) with a feed water tank (1) connected thereto, said components being integrated into the water/steam cycle of a solar thermal power station that has a heat transfer medium circuit with an associated water/steam cycle. The aim of the invention is to provide a solution, which in terms of the heating and control process provides a less complex way of supplying the degasifier with heating steam in comparison with prior art. To achieve this, at least one additional evaporator (11), which has a line connection (12) on the water side to the feed water region (5) of the feed water tank (1) and a line connection (13) on the steam side to the steam region (6) of the feed water tank (1), is allocated to the feed water tank (1).

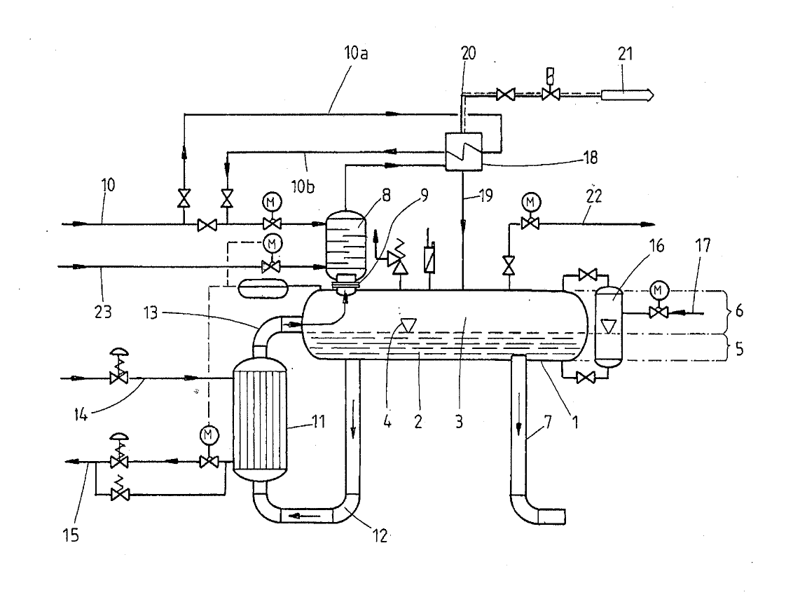

The invention is directed to a feedwater degasifier comprising a degasifier with a connected feedwater tank, which are incorporated in the water/steam cycle of a solar thermal power station that has a heat transfer medium circuit with an assigned water/steam cycle. The invention is also directed to a solar thermal power station with such a feedwater degasifier and to a method for feedwater degasification and/or feedwater heating of feedwater provided in the water/steam cycle of a solar thermal power station in a feedwater tank with a degasifier.

Solar thermal power stations often have a heat transfer medium circuit and a water/steam cycle coupled therewith via heat exchangers, with a steam turbine arranged therein for the conversion of thermal energy into mechanical energy and with a connected generator for generating electrical energy. This involves, for example, using solar elements in the form of parabolic reflectors, which are put together in individual solar rows to form a solar array, to direct solar energy in a targeted manner onto absorbers in which the heat transfer medium flows. In such reflector or solar arrays, the thermal energy is in this way transferred to the heat transfer medium, usually a thermal oil, in a so-called HTF system (Heat Transfer Fluid system). This thermal oil of the heat transfer medium circuit then gives off its thermal energy to the water conducted in the water/steam cycle in heat exchangers. In the HTF system, the thermal oil as the heat transfer medium is heated up to about 400° C., which by heat transfer to the water conducted in the water/steam cycle produces steam of about 390° C. and 100 bar. The at least one steam turbine with a connected generator is then operated using the steam, which after that is condensed and then conducted again as water in the water/steam cycle.

In the heat transfer medium circuit there may also be an integrated thermal store (TES), which is fed part of the heat transfer medium, which in the store then gives off thermal energy a storage medium. At times when there is no sunshine, the heat storage material or the storage medium of the thermal store can then give off the stored thermal energy to the heat transfer medium again, and thereby make it usable.

To keep the water/steam cycle operational, the water conducted in the water/steam cycle must be regularly processed. The water/steam cycles of thermal power stations, which operate on the basis of the so-called Clausius-Rankine cycle process, this often also applying to the water/steam cycle of solar thermal power stations, include an apparatus referred to as a degasifier or feedwater degasifier, in which so-called main condensate, which consists of the condensed exhaust steam of the steam turbine(s) and additional fully deionized water, is processed into boiler feedwater and kept or provided in an assigned feedwater tank. This processing of the feedwater comprises the degasification of the main condensate by driving out and carrying away gases that cannot be condensed, such as nitrogen, carbon dioxide and oxygen, by mechanical trickling of the condensate in the degasifier and, in particular, by a heating of the condensate by 15 to 30 K performed there. Furthermore, the processing comprises the checking and setting of a pH value to be maintained, which is achieved by introducing and/or adding metered amounts of ammonia. Similarly, the checking and setting of the (residual) oxygen content in the water is important, and this may be performed by increasing the flow of vapor at the upper dished boiler end of the degasifier. Finally, the processing of the main condensate into feedwater comprises the continuous (intermediate) storage of the processed (boiler) feedwater in the feedwater vessel or feedwater tank, to continuously and permanently provide feedwater, which can then be fed at any time to the steam generator via so-called high-pressure feedwater pumps.

Furthermore, the known solar thermal power stations often have so-called “auxiliary boiler” systems or “auxiliary boilers”, which are assigned to the water/steam cycle and/or are integrated in it. These auxiliary boiler systems are necessary in standby mode and when starting up and shutting down the water/steam cycle to allow steam that is nevertheless necessary for the process to be produced. These auxiliary boiler systems are generally fossil-fired and must, for example, provide sealing steam for the shaft seals of the steam turbines, operating steam for the vacuum pumps for evacuating the steam turbine exhaust-steam condenser and the main-condensate and high-pressure feedwater preheaters. Furthermore, these auxiliary boiler systems make heating steam available to the degasifier with the connected feedwater tank for the necessary heating and degasification of main condensate at times outside regular steam generator and/or steam turbine operation. However, these “auxiliary boiler” systems or “auxiliary boilers” are not fed with water from the feedwater tank or tanks of the regular main water/steam cycle of the solar thermal power station, but have a separate water supply of their own.

Particularly if it is fossil-fired, such an auxiliary boiler system immediately reduces the environmental benignity of a solar thermal power station on account of the associated CO₂ exchange. In particular, in terms of plant engineering, such auxiliary boiler systems are relatively complex additional units, which also necessitate a control system that is sophisticated, sensitive and difficult to adjust.

The invention is based on the object of providing a solution which, in terms of the heating and control process, provides a less complex possible way of supplying the degasifier with (heating) steam.

In particular, it is also intended to provide the possibility of providing steam and/or hot feedwater outside regular “normal” steam generator and steam turbine operation for the operating phases of standby operation and/or starting-up and/or shutting-down operation of the water/steam cycle of a solar thermal power station.

In the case of a feedwater degasifier and a solar thermal power station of the type referred to at the beginning, this object is respectively achieved according to the invention by the feedwater tank being assigned at least one additional evaporator with a line connection on the water side to the feedwater region of the feedwater tank and with a line connection on the steam side to the steam region of the feedwater tank.

In the case of a method of the type referred to at the beginning, this object is achieved according to the invention by at least part of the feedwater being fed to an additional evaporator assigned to the feedwater tank and evaporated therein and the steam being returned into the steam region of the feedwater tank.

Advantageous refinements and expedient developments of the subjects of the invention are provided by the respective subclaims.

The invention provides that the feedwater tank of the degasifier is directly assigned at least one additional evaporator, which is also advantageously located in the direct proximity of the feedwater tank. This makes it possible to realize a natural circulation between the feedwater tank and the additional evaporator over a short path, which can be handled unproblematically in terms of the heating and control process. Altogether, this creates the possibility of being able to supply the degasifier with the connected feedwater tank with heating steam in a less complex way. The invention makes it possible to make a degasifier with a feedwater tank into a multifunctional, thermal-degasifier, preheating and auxiliary-steam generator plant. Such a plant can be used for rapid, but nevertheless unharmful starting up and shutting down of a solar thermal power station and obviates the need for an otherwise customarily provided auxiliary boiler plant of much greater dimensions. The term “additional evaporator” has been chosen here because the water/steam cycle of the solar thermal power station of course has a steam generator, which comprises evaporators, superheaters, intermediate superheaters, etc., which however are remote from and additional to the additional evaporator.

Such a direct assignment of an additional evaporator is of particular advantage whenever the at least one additional evaporator can be heated and/or is heated by the heat transfer medium of the heat transfer medium circuit, as the invention provides in a refinement of the feedwater degasifier. This makes it possible, for example, to provide a thermal-oil-heated natural-circulation evaporator which no longer necessitates separate, fossil generated firing of its own and which makes degasified and preheated feedwater available to the water/steam cycle for maintaining the temperature and for starting up and shutting down the solar thermal power station.

Advantageously, the at least one additional evaporator is heated by means of a subflow branched off from the heat transfer medium circuit.

The heat transfer medium is, in particular, a liquid, customarily used thermal oil. The invention is therefore also distinguished in a further refinement by the fact that the heat transfer medium is a thermal oil and/or the additional evaporator is a natural-circulation evaporator.

To be able to integrate the feedwater degasifier according to the invention and the feedwater tank into customary water/steam cycle systems without making modifications to the latter and connect them to a steam/water cycle, it is provided according to a further refinement of the invention that the feedwater tank is incorporated in the water/steam cycle by way of a feedwater line and the feedwater degasifier is incorporated in the water/steam cycle by way of a main condensate line.

A particularly expedient configuration of an evaporator can be formed by the additional evaporator being formed as a heat exchanger. This offers the possibility of conducting the heat transfer medium through an additional evaporator formed as a heat exchanger in counterflow to the naturally circulating and boiling feedwater, the water boiling in the additional evaporator then being conducted in the heat exchanger tubes and the liquid heat transfer medium in the form of the thermal oil running along the outside of the heat exchanger tubes. The invention therefore also provides that the additional evaporator is a heat exchanger.

Since the refinement according to the invention of the feedwater degasifier with a connected feedwater tank provided by assigning an additional evaporator obviates the need for an otherwise customary auxiliary boiler plant, the solar thermal power station according to the invention is distinguished in a refinement in that it does not have an auxiliary boiler, in particular a solar-heated auxiliary boiler, assigned to the heat transfer medium circuit and/or the water/steam cycle.

It is also of advantage if the solar thermal power station has a feedwater tank as claimed in one of claims 2 to 6, which the invention likewise provides. The solar thermal power station then has the same advantages as are mentioned above in connection with the feedwater degasifier.

In the context of a solar thermal power station which is equipped with a heat transfer medium circuit including the respective solar array, it is expedient to heat the additional evaporator with this heat transfer medium, which may in particular be thermal oil. The method according to the invention therefore provides in a refinement that the additional evaporator is heated by the heat transfer medium of the heat transfer medium circuit.

Here it is then of particular advantage if the feedwater is moved between the feedwater tank and the additional evaporator by means of natural circulation, which the invention also provides. This makes it possible to provide a degasifier for various operating modes of the solar power station which, with its assigned natural-circulation additional evaporator arranged in particular in the proximity of the feedwater tank and preferably heated by thermal oil, can provide preheated and degasified feedwater and auxiliary steam in a great mass flow bandwidth for the water/steam cycle of the solar thermal power station on a permanent and highly flexible, quickly and dependably controlled basis.

With the branching off of an HTF subflow, it is possible to provide heating of the additional evaporator without great effort in terms of the control process and/or structural design and/or provision of lines.

To allow the additional evaporator, and consequently the degasifier with a feedwater tank in connection therewith by way of lines and with operational effect, to be formed as a multifunctional thermal-degasifier, preheating and auxiliary-steam generator plant for the water/steam cycle of the solar thermal power station, it is also of advantage if the additional evaporator is fed 0.5% to 45% of the feedwater flow made available altogether to the steam/water cycle at full steam-turbine load.

According to a development of the invention, here there is then the possibility of keeping the feedwater of the feedwater tank at a temperature in the range of its boiling point in the standby operating mode of the power station by circulation through the additional evaporator. As a result, sufficiently hot feedwater for rapid hot starting up of the steam generator(s) and the steam turbine(s) is available at any time.

Since the additional evaporator in the standby operating mode of the power station can make sufficient auxiliary steam available to the water/steam cycle for this operating mode, it is then also of advantage if no feeding of external auxiliary steam takes place in the standby operating mode, by which the invention is likewise distinguished. Here the evaporator should then be operated with minimal heat transfer medium throughput and extremely small power output in the standby operating mode.

With the combination according to the invention of feedwater degasifier, feedwater tank and additional evaporator, it is possible not only to maintain the temperature of the feedwater in the standby operating mode of the solar thermal power station but also to assist the hot starting up of the power station. This is so because the additional evaporator can provide mass flow of water vapor that goes well beyond the mass flow of water vapor required just to maintain the temperature of the feedwater. Until its full thermal load is reached, the additional evaporator can therefore be used for the starting up or running up of the power station. The method according to the invention therefore finally provides in a refinement that, in the hot starting-up mode of the power station, the thermal output of the additional evaporator is run up steplessly to its full thermal load and at the same time the steam pressure is controlled by means of a steam-pressure setpoint control.

After carrying out the starting-up operation of the power station, the additional evaporator is then preferably run down again after reaching its full load range, the thermal energy required for the degasifier then being provided as otherwise customary in the water/steam cycle of solar thermal power stations by means of the bled steam fed to the degasifier. The invention is therefore finally distinguished by the fact that, when a predetermined (live) steam pressure is reached, in particular in the live steam line, and/or when a specific part-load range of the steam turbine of the power station is reached, bled steam from the water/steam cycle is fed to the degasifier and the additional evaporator is switched over to a standby temperature-maintaining mode and is operated in this mode.

It goes without saying that the features mentioned above and still to be explained below can be used not only in the respectively indicated combination, but also in other combinations. The scope of the invention is only defined by the claims.

The invention is explained in more detail below on the basis of an exemplary embodiment with reference to an associated drawing. This shows in the single FIGURE, in a schematic representation, the arrangement of a feedwater degasifier according to the invention with an assigned feedwater tank and an additional evaporator assigned to the latter.

The single FIGURE shows a cylindrical feedwater vessel or feedwater tank 1, which is arranged lying horizontally and in which there is feedwater 2 at the bottom and saturated steam 3 in the region formed thereabove. The region of the feedwater tank 1 that is filled with feedwater 2 up to the liquid bath level 4 is referred to hereafter as the feedwater region 5 and the region formed thereabove is referred to hereafter as the steam region 6 of the feedwater tank 1. In the feedwater region 5, degasified feedwater for the water/steam cycle of the connected solar thermal power station (not represented) is provided and kept ready. The feedwater tank 1 is connected to the water/steam cycle via a feedwater line 7, through which the water/steam cycle is fed degasified feedwater 2 in the direction of the arrow indicated in the tube 7.

Arranged above the steam region 6 on the feedwater tank 1 is an upright cylindrical degasifier 8, in the present exemplary embodiment a trickling tray degasifier. It is in connection with the steam region 6 of the feedwater tank 1 via a flanged connection 9 designed such that it cannot be shut off. The degasifier 8 is entered in its upper region by the main condensate line 10, via which the degasifier/feedwater tank combination according to the invention is incorporated in the water/steam cycle of the power station downstream of the steam turbines on the steam side.

Also assigned, particularly in close proximity, to the feedwater tank 1 is an additional evaporator 11, which is also arranged laterally close to the feedwater tank 1. The additional evaporator 11 has a line connection 12 on the water side to the feedwater region 5 of the feedwater tank 1 and a line connection 13 on the steam side to the steam region 6 of the feedwater tank 1. By heating the additional evaporator 11, which takes the form of a heat exchanger, a natural circulation of the feedwater 2 based on the so-called thermosiphon principle can form in the line connections 12, 13 from the feedwater tank 1 to the additional evaporator 11 and from the additional evaporator 11 back to the feedwater tank 1. The heating of the additional evaporator 11 takes place by means of the heat transfer medium circulating in the heat transfer medium circuit of the assigned solar thermal power station, this being a thermal oil in the exemplary embodiment. The heat transfer medium is fed to the additional evaporator 1 at a (its) higher temperature level via a feed line 14 and is fed via the discharge line 15 back out of the additional evaporator 11 and to the heat transfer medium circuit at a lower temperature level. The evaporator 11, configured in the exemplary embodiment as a thermal-oil-heated natural-circulation additional evaporator, comprises a straight-tube heat exchanger, in which the hot thermal oil fed through the feed line 14 is conducted along the outside and past the heat exchanger tubes to the discharge line 15 and, in counterflow thereto, the feedwater 2 that is fed through the line connection 12 on the water side is fed to the line connection 13 on the steam side in a boiling and possibly evaporating state. The additional evaporator 11 is mounted laterally on, or at least in the proximity of, the feedwater tank 1, so that the line connections 12, 13 can be made relatively short.

Also arranged on the feedwater tank 1 is an upright flash cylinder 16, which at one end likewise has a line connection on the water side to the feedwater region 5 of the feedwater tank 1 and at the other end has a line connection on the steam side to the steam region 6 of the feedwater tank 1. The flash cylinder 16 is entered by a line 17, through which heating steam condensate originating from the high-pressure feedwater preheaters of the water/steam cycle can be introduced into the flash cylinder 16 and from there can be returned without any trouble into the feedwater tank 1.

On its side facing away from the feedwater tank 1, the degasifier 8 is also line-connected to a main-condensate-cooled vapor condenser 18. The vapor condenser 18 is formed as a lying straight-tube heat exchanger, the cooling main condensate that is fed via a line 10a branched off from the main condensate line 10 flowing in the heat exchanger tubes and being returned into the main condensate line 10 via a branch line 10b. The vapor produced in the degasifier 8 and containing the gases that cannot be condensed, such as CO₂, O₂ or N₂, is conducted along the outside and past the heat exchanger tubes of the vapor condenser 18. As a result, the water-containing parts of the vapor condense and are then returned again as condensate into the steam region 6 of the feedwater tank 1 via a line 19. The remaining, non-condensing gas components, in particular the CO₂, O₂ and N₂ to be degasified, are carried away as exhaust gas 21 via a line 20.

Using the additional evaporator 11 makes it possible to heat the feedwater 2, it being possible for this to take place under closed-loop and open-loop control, so that a specific evaporation of feedwater that is desired in a respective operating mode of the solar thermal power station can take place using the additional evaporator 11. This additional unit turns the degasifier/feedwater tank arrangement, which otherwise is in principle of a conventional design, into a multifunctional, thermal-degasifier, preheating and auxiliary-steam generator plant. This can be used for more rapid, and nevertheless unharmful starting up and shutting down of the solar thermal power station, i.e. the regular water/steam cycle thereof. A separate, generally fossil-fired auxiliary boiler plant that is otherwise necessary for this purpose in the case of conventional solar thermal power stations is consequently no longer necessary.

The combination comprising not only the degasifier 8 and the feedwater tank 1 but also the additional evaporator 11 in the form of the thermal-oil-heated natural-circulation evaporator, makes degasified and preheated feedwater available in the feedwater tank 1 to the water/steam cycle of the connected and assigned solar thermal power station via the feedwater line 7 for maintaining the temperature and for starting up and shutting down the solar thermal power station. Depending on the operating state of the solar thermal power station, preheated feedwater 2 is taken from the feedwater tank 1 and returned to it again after flowing through the additional evaporator 11 in an amount which corresponds to 0.5% to 45% of the throughput of feedwater mass flow that is taken from the feedwater tank 1 in the regular operating mode subsequent to maintaining the temperature or starting up or prior to shutting down, in particular in full steam-turbine load operation, in which the customary preheating of the feedwater 2, still to be explained below, takes place by means of main condensate fed through the line 10.

The invention provides a combination of degasifier 8, feedwater tank 1 and additional evaporator 11 which provides auxiliary steam in a (great) mass flow bandwidth of 0.22 to −5 kg of steam/s for the water/steam cycle by means of the thermal-oil-heated natural-circulation evaporator 11 on a permanent and highly flexible, quickly and dependably controllable basis.

With the feedwater degasifier 8 according to the invention, it is possible for the first time to supply extremely small auxiliary steam mass flows in the range of 0.22-0.25 kg of steam/s in the standby operating mode of the solar thermal power station. In this standby operating mode, in which the water/steam cycle is kept ready for the next hot start, extremely small auxiliary steam mass flows of 0.22-0.25 kgs flow in a manner stably and quickly controlled by means of a set steam-pressure setpoint value from the saturated steam region 6 of the feedwater tank 1 via a line 22 as auxiliary steam or extraneous steam into the auxiliary steam collector (not represented) of the water/steam cycle of the connected solar thermal power station, and from there into the sealing steam system of the associated or assigned steam turbine and into the operating steam system of the vacuum pumps of the evacuation system of the water/steam cycle. In this operating state, the auxiliary steam collector is supplied with auxiliary steam as it were “in reverse”, since the feedwater tank 1 with the assigned feedwater degasifier 8 in this operating mode produces and discharges auxiliary steam but not steam such as that which is, for example, supplied via the bled steam line 23, required and consumed in the regular operating mode of the power station.

At the same time and in parallel with the discharge of auxiliary steam, in this standby operating mode of the power station the temperature of the feedwater 2 in the feedwater tank 1 is maintained without supplying external auxiliary steam from the outside just by using the feedwater circulation that is circulated through the additional evaporator 11. Since no steam, and consequently water, is supplied from the outside, there is also no increase in the liquid bath level 4, which would have the consequence that at some time feedwater would have to be drained out of the feedwater vessel 1, as is necessary in the case of previously conventionally operated feedwater degasifiers according to the prior art. The feedwater degasifier 8 according to the invention with the feedwater tank 1 contains feedwater 2 which is at a temperature in the range of its boiling point and can be made available to the water/steam cycle via the feedwater line 7 at any time, for example when starting up of the steam generator and steam turbine is intended to take place.

In this standby operating mode of the power station, the thermal-oil-heated natural-circulation evaporator 11 is operated with a minimal thermal oil throughput of about 22 kg/s at an extremely small power output of about 0.44 MW, the required thermal oil being branched off from the return of the in any case required thermal oil circulation in the heat transfer medium circuit of the power station and returned to there. This branching off of heat transfer medium for the heating of the additional evaporator 1 from the return portion of the heat transfer medium circuit makes it possible to feed the additional evaporator 11 heat transfer medium without additionally requiring auxiliary units just for this purpose that would then have to be kept ready in an inactive state in the regular operating mode of the power station.

However, the combination according to the invention of degasifier 8, feedwater tank 1 and additional evaporator 11 also offers support in the hot starting up of the steam generator and steam turbine when the power station is in a hot starting-up mode. In this mode, the thermal output of the thermal-oil-heated natural-circulation evaporator 11 is increased from the small load adjusted in the standby mode (0.44 MW) steplessly up to its full thermal load (10 MW) and thereby stably and quickly controlled by means of a steam-pressure setpoint value control system. For rapid starting up of the steam generator, when the full thermal load in the additional evaporator 11 of 10 MW is reached, about twice the thermal output that is transferred in regular, steady-state full-load operation of the water/steam cycle is transferred into the main condensate within the feedwater degasifier plant or within the degasifier 8. The full load in the additional evaporator 11 of 10 MW in the final phase of the boiler and steam-turbine start-up means that 200% of the nominal heat transfer performance that is achieved in the case of full steam-turbine load is reached in the feedwater degasification plant or in the degasifier 8.

The reason for this high, double thermal output consumption of the additional evaporator 11 is that the main condensate flowing in through the main condensate line 10 in this operating state is still cold and consequently must be heated up in the degasifier 8 not only by the usual order of magnitude of 15 to 30 K, to the temperature necessary for the thermal degasification, but must be heated up by the order of magnitude of 110 to 120 K, in order to obtain the temperature necessary for the feedwater preheating and evaporation.

In the trickling tray degasifier 8, about twice the nominal heat transfer performance occurs.

In this hot starting-up phase, the steam throughput in the steam generator and in the steam turbine is increased in accordance with the respectively predetermined temperature gradients and preheated feedwater 2 is removed from the feedwater tank 1 by means of feedwater pumps via the feedwater line 7 in accordance with the amount of steam to be fed to the steam generator and the steam turbine. As a result, the feedwater level, i.e. the feedwater bath level 4, in the feedwater tank 1 drops and goes below a predetermined water-level setpoint value. As a result, a control valve, which brings about the flowing of main condensate via the main condensate line 10 into the degasifier 8, is opened by means of a water level controller. The main condensate that has entered the degasifier 8 then trickles uniformly from the top downward over the trickling trays of the degasifier 8, while at the same time saturated steam from the steam region 6 of the feedwater tank 1 flows through the degasifier in counterflow from the bottom upward. In the course of the counterflow, the saturated steam flowing through the degasifier gradually condenses in direct contact with the main condensate and thereby gives off its heat of condensation or enthalpy of vaporization to the main condensate. This has the effect that the temperature of the main condensate increases and the gases that cannot be condensed contained therein, in particular CO₂, O₂ and N₂, inevitably become detached from the increasingly hotter main condensate and escape with the so-called vapor from the degasifier 8 and are fed through a line to the vapor condenser 18, from which they then escape from the water/vapor cycle via the line 20 as exhaust gas 21.

In the vapor condenser 18, the vapor is cooled using the main condensate conducted in heat exchanger tubes and fed via a line 10a and condenses. The vapor condenses almost completely and is returned into the feedwater tank 1 via the line 19 in the form of water. The gases that cannot be condensed (CO₂, O₂ and N₂) are discharged via the line 20 as exhaust gas 21 into the ambient air or atmosphere with a minimal residue of the vapor.

In the case of the operation described above, saturated steam flows out of the steam region 6 of the feedwater tank 1 into the degasifier 8 and condenses there on the counterflowing main condensate. As a result, the steam pressure in the steam region 6 of the feedwater tank 1 drops, whereupon a steam pressure controller opens a control valve in the feed line 14, so that the evaporator 11 is fed hot heat transfer medium, in the present case thermal oil, at its higher temperature level, or is fed said medium in a greater amount. This has the effect of producing a greater temperature gradient in the additional evaporator 11 between the side of the feed line 14 and the side of the discharge line 15, whereby the natural circulation for the feedwater that is connected via the lines 12 and 13 speeds up directly without delay and without any fluid- and/or thermodynamic impediments, such as for instance undesired steam implosions. As a consequence, the feedwater mass flow conducted through the additional evaporator 11 is speeded up, more feedwater per unit of time evaporates, and the steam pressure in the steam region 6 is further increased. As much feedwater is evaporated by means of the additional evaporator 11 as is necessary for heating, degasifying and post-boiling the main condensate and for maintaining the desired and set steam pressure in the steam pressure region 6.

Finally, the combination of feedwater degasifier 8, feedwater tank 1 and additional evaporator 11 is then operated again in a standby mode when the steam generator and the steam turbine have reached their regular operating state and/or while the steam generator and the steam turbine or the steam-turbine generator set are in the operating state of the run-up constant-pressure mode.

This standby mode of the degasifier 8 according to the invention is set as soon as a specific, desired live steam pressure is established in the steam generator and/or in the live steam line and the steam turbine has reached a desired, specific part-load range, this limit preferably being reached when the generator connected to the steam turbine has reached 20% of its generator output. In this case, the standby mode of the degasifier 8 is then initiated by the heating output of the thermal-oil-heated natural-circulation evaporator 11 being reduced by throttling the thermal oil flowing in as the heat transfer medium. At the same time, heating steam fed through the bled steam line 23 flows through the degasifier 8 and brings about the corresponding degasification of the counterflowing main condensate there. The main condensate then has in this operating state of the solar thermal power station an increased temperature in comparison with the starting-up mode, so there is no longer any “cold” main condensate, since it can be preheated by the heat exchanger supplied with heating steam. In this mode, the additional evaporator 11 with the connected feed line 14 is switched and programmed in such a way that it is activated and makes more thermal output available again for the heating up of feedwater when there is a sudden and undesired pressure drop in the degasifier 8 and/or the feedwater tank 1 that is not immediately compensated by increased bled or heating steam being fed through the line 23.

Otherwise, the additional evaporator 11 in this evaporator standby operating mode is merely operated once again with a minimal thermal oil throughput of <8 kg/s, so that a low feedwater circulation takes place. On account of the inflow of heat transfer medium, the temperatures of the feed line 14 and, due to the resultant circulation of the feedwater, of the additional evaporator 11 with the line connection 12 on the water side and the line connection 13 on the steam side are respectively maintained and kept at operating temperature. This measure makes it possible in particular that saturated steam can be produced at short notice by means of the additional evaporator 11 if the steam pressure in the degasifier 8 and/or in the feedwater tank 1 drops.

It is provided here that the setpoint value of a pressure-maintaining controller floats with the actual pressure value in the feedwater tank 1 and “freezes” this actual value if a specific pressure drop gradient is exceeded. Maintaining the pressure in this way prevents operational failures of the feedwater pump and consequently the availability of the power station process as a whole is ensured and/or increased.

Altogether, with the invention the system components that are provided as part of a solar thermal power station, the solar array, HTF (Heat Transfer Fluid) system and thermal store (TES), are optimally used and incorporated in the feedwater degasification, so that it is possible to dispense with a conventional, in particular fossil-fired, further auxiliary boiler plant for producing auxiliary steam that is customarily required according to the prior art.

The thermal energy generated in the solar array of the solar thermal power station can be made available to the additional evaporator 11 and/or the feedwater 2 in four different ways:
1. In normal operation when there is solar irradiation, the thermal energy is supplied directly via the feed line 14 by way of the heat transfer medium (Heat Transfer Fluid) heated in the solar array.
2. At times when the sun is not shining, thermal energy can be discharged from a thermal store (TES) to the heat transfer medium (HTF). For example, the thermal store may be a molten-salt heat reservoir, which in the discharge mode then gives off the stored thermal energy to the heat transfer medium, in the exemplary embodiment thermal oil, which then in turn supplies the thermal energy via the feed line 14 to the additional evaporator 11.
3. Stored thermal energy may be discharged to the additional evaporator 11 as residual heat via the heat transfer medium. After all the aforementioned heat sources have been switched off or eliminated, the HTF mass (about 2000 t) from the heat transfer circuit can give off heat to the additional evaporator 11, until it has cooled down from about 300° C. to about 190° C.
4. Thermal energy from the combustion of natural gas in the so-called heat transfer fluid heater can be provided via the heat transfer medium. If the temperature falls below specific HTF setpoint temperatures, the HTF is brought to or kept at a temperature depending on the operating mode by burning natural gas.

The combination according to the invention of the degasifier 8 with the feed tank 1 and the assigned additional evaporator 11 leads to a series of further advantages. With this system a simple cold start of the evaporator and of the feedwater degasifier that is unproblematic in terms of the heating and control process is possible on account of the natural circulation of the additional evaporator or heat exchanger based on the thermosiphon principle. No separate internals are necessary in the feedwater tank and no separate steam lines, complicated control systems etc. are necessary. For the operation of the additional evaporator 11 it is sufficient to branch off a feed line 14 from the heat transfer medium circuit and return a discharge line 15 to there. Additional pumps to conduct the heat transfer medium through the lines 14 and 15 and the additional evaporator 11 are not necessary. The pumps circulating the heat transfer medium in the heat transfer medium circuit are sufficient also to transport the heat transfer medium through the lines 14, 15.

1. A feedwater degasifier comprising a degasifier with a connected feedwater tank, which are incorporated in the water/steam cycle of a solar thermal power station that has a heat transfer medium circuit with an assigned water/steam cycle, wherein the feedwater tank is assigned in the direct proximity thereof at least one additional evaporator with a line connection on the water side to the feedwater region of the feedwater tank and with a line connection on the steam side to the steam region of the feedwater tank.

2. The feedwater degasifier as recited in claim 1, wherein the at least one-additional evaporator can be heated and/or is heated by the heat transfer medium of the heat transfer medium-circuit.

3. The feedwater degasifier as recited in claim 1, wherein the additional evaporator can be heated and/or is heated by a subflow branched off from the heat transfer medium-circuit.

4. The feedwater degasifier as recited in claim 1, wherein the heat transfer medium is a thermal oil.

5. The feedwater degasifier as recited in claim 1, wherein the feedwater tank is incorporated in the water/steam cycle by a feedwater line and the feedwater degasifier is incorporated in the water/steam cycle by a main condensate line.

6. The feedwater degasifier as recited in claim 1, wherein the additional evaporator is a heat exchanger.

7. A solar thermal power station with a feedwater degasifier comprising a degasifier with a connected feedwater tank, which are incorporated in the water/steam cycle of the power station having a heat transfer medium circuit with an assigned water/steam cycle, wherein the feedwater tank is assigned in the direct proximity thereof at least one additional evaporator with a line connection on the water side to the feedwater region of the feedwater tank and with a line connection on the steam side to the steam region of the feedwater tank.

8. The solar thermal power station as recited in claim 7, wherein the solar thermal power station does not have an auxiliary boiler assigned to the heat transfer medium circuit and/or the water/steam cycle.

9. The solar thermal power station as recited in claim 7, wherein the additional evaporator of the feedwater degasifier can be heated and/or is heated by the heat transfer medium of the heat transfer medium circuit.

10. A method for feedwater degasification and/or feedwater heating of feedwater provided in the water/steam cycle of a solar thermal power station in a feedwater tank with a degasifier, wherein at least part of the feedwater is fed to an additional evaporator assigned to the feedwater tank with degasifier in the direct proximity thereof and evaporated therein and the steam is returned into the steam region of the feedwater tank.

11. The method as recited in claim 10, wherein the additional evaporator is heated by the heat transfer medium of the heat transfer medium circuit.

12. The method recited in claim 10, wherein the feedwater is moved between the feedwater tank and the additional evaporator by means of natural circulation.

13. The method recited in claim 10, wherein the additional evaporator is fed 0.5% to 45% of the feedwater mass flow made available altogether to the steam/water cycle at full steam-turbine load.

14. The method recited in claim 10, wherein the feedwater of the feedwater tank is kept at a temperature in the range of its boiling point in the standby operating mode of the power station by circulation through the additional evaporator.

15. The method recited in claim 10, wherein no feeding of external auxiliary steam into the degasifier takes place in the standby operating mode of the power station.

16. The method recited in claim 10, wherein, in the hot starting-up mode of the power station, the thermal output of the additional evaporator is run up steplessly to its full thermal load and the steam pressure is controlled by a steam-pressure setpoint control.

17. The method recited in claim 10, wherein, when a predetermined steam pressure is reached and/or when a specific part-load range of the steam turbine of the power station is reached, bled steam from the water/steam cycle is fed to the degasifier and the additional evaporator is switched over to a standby temperature-maintaining mode and is operated in this mode.

18. The feedwater degasifier as recited in claim 1, wherein the additional evaporator is a natural-circulation evaporator.

19. The feedwater degasifier as recited in claim 1, wherein the solar thermal power station does not have a solar-heated auxiliary boiler assigned to at least one of the heat transfer medium circuit or the water/steam cycle.

20. The solar thermal power station as recited in claim 7, wherein the additional evaporator of the feedwater degasifier is a heat exchanger.

21. The method recited in claim 10, wherein, when a predetermined live steam pressure is reached in the live steam line and/or when a specific part-load range of the steam turbine of the power station is reached, bled steam from the water/steam cycle is fed to the degasifier and the additional evaporator is switched over to a standby temperature-maintaining mode and is operated in this mode.
